(19) United States
(12) Patent Application Publication
(10) Pub. No.: US 2012/0069577 A1
(43) Pub. Date: Mar. 22, 2012

(54) LENS AND LIGHT SOURCE MODULE

(75) Inventor: HSIU-PING CHANG, Chu-Nan (TW)

(73) Assignee: FOXSEMICON INTEGRATED TECHNOLOGY, INC., Chu-Nan (TW)

(21) Appl. No.: 13/233,175

(22) Filed: Sep. 15, 2011

(30) Foreign Application Priority Data
Sep. 16, 2010 (TW) 099131485

(51) Int. Cl. F21V 5/04; F21V 7/00

(52) U.S. Cl. 362/296.01; 362/335; 362/327; 362/311.09

(57) ABSTRACT

A lens includes a light incident surface, a first light emitting surface, and a second light emitting surface. The light incident surface is a concave surface and defines a receiving recess. The first light emitting surface is a convex curved surface and is opposite to the light incident surface. The first light emitting surface includes a first border, and the first light emitting surface and the light incident surface cooperatively form a convex lens portion with an optical axis. The second light emitting surface is located at a side of the first light emitting surface and adjacent to the first border. The longer the distance between a point of the second light emitting surface and the optical axis is, the longer the distance between the point and the light incident surface is.

### BACKGROUND

1. Technical Field

The present disclosure relates to optical field and, particularly, to a lens and a light source module having the lens.

2. Description of Related Art

At present, the light emitted from many types of light sources, such as light emitting diodes, discharge lamps, and halogen lamps etc., has a large divergence angle. When one of these types of light sources is provided for long-distance illumination, a focus lens is generally required at the front of it to reduce the divergence angle and focus the light near the optical axis. However, in some products, such as vehicle lamp etc., not only long-distance illumination for illuminating the distant place ahead of the vehicle is needed, but short-distance illumination for illuminating the ground near the vehicle is also needed. Therefore, the conventional focus lens could not satisfy the above described application.

What is needed is a lens which can ameliorate the problem of the prior art.

### BRIEF DESCRIPTION OF THE DRAWINGS

Many aspects of the present lens and light source module can be better understood with reference to the accompanying drawings. The components in the drawings are not necessarily drawn to scale, the emphasis instead being placed upon clearly illustrating the principle of the lens and light source module. In the drawings, all the views are schematic.

FIG. 1 is a schematic view of a light source module according to an exemplary embodiment.

FIG. 2 is a cross sectional view of the light source module taken along line II-II of FIG. 1.

### DETAILED DESCRIPTION

Embodiments of the present disclosure will now be described in detail below, with reference to the accompanying drawings.

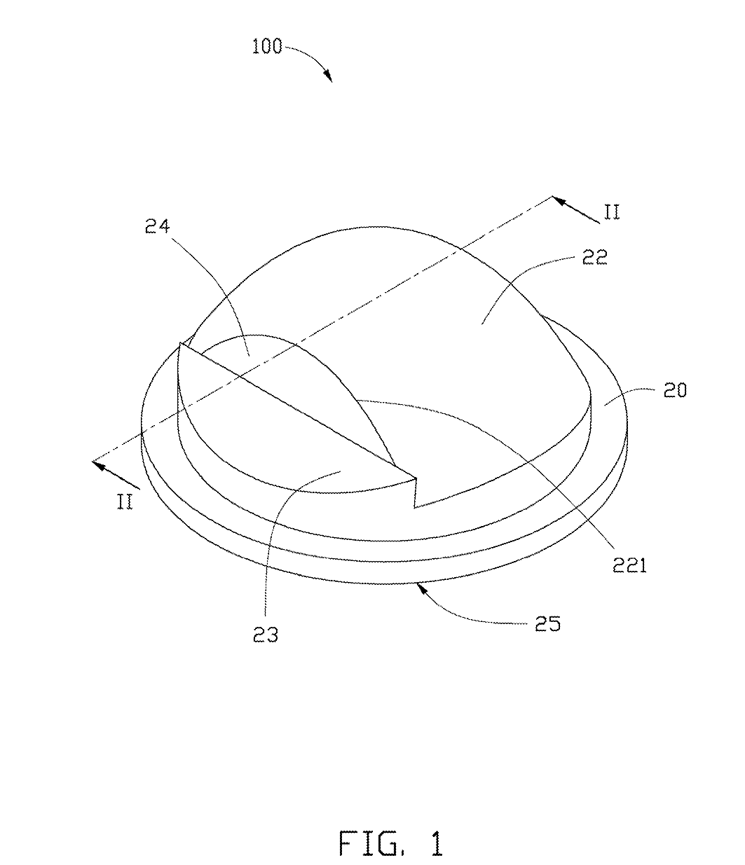

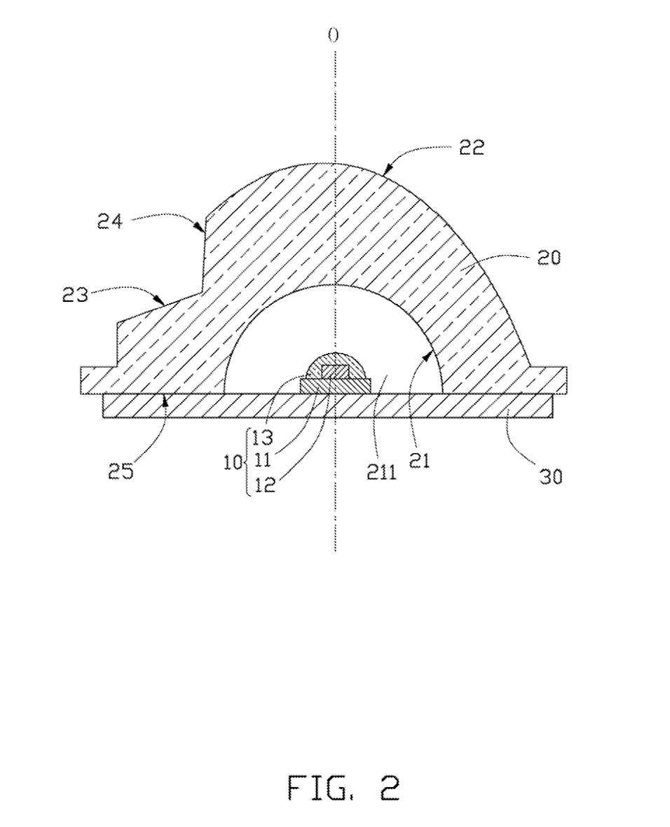

Referring to FIGS. 1 and 2, a light source module 100 according to an exemplary embodiment is shown. The light source module 100 includes a light source 10 and a lens 20. The light source module 100 can be used in vehicle lamps etc.

The light source 10 can be a light emitting diode, a discharge lamp, or a halogen lamp etc. In the present embodiment, the light source 10 is a light emitting diode including a base 11, a chip 12, and an encapsulant 13. The chip 12 is mounted on a top surface of the base 11, and the encapsulant 13 is formed on the top surface of the base 11 to cover the chip 12. The light emitting diode can be mounted on a circuit board 30 by surface mounting technology etc.

The lens 20 includes a light incident surface 21, a first light emitting surface 22, a second light emitting surface 23, and a connecting surface 24. The connecting surface 24 connects the first light emitting surface 22 to the second light emitting surface 23. The first light emitting surface 22 and the second light emitting surface 23 are opposite to the light incident surface 21.

The light incident surface 21 is a concave surface and defines a receiving recess 211. The light source 10 can be received in the receiving recess 211. If the light source 10 is received in the receiving recess 211, almost all light emitted from the light source 10 can be incident on the light incident surface 21. The concave surface can be made up of a number of flat surfaces, or can be made up of at least one curved surface. In the present embodiment, the light incident surface 21 is a concave curved surface. The lens 20 further includes a ring-shaped flat surface 25 surrounding the light incident surface 21. The ring-shaped flat surface 25 extends outwardly from a bottom edge of the light incident surface 21. Because the light source 10 of the present embodiment is a light emitting diode, the ring-shaped flat surface 25 can be attached to the circuit board 30 to secure the lens 20 thereto; therefore, there is no need to provide the lens 20 with a special structure in order to secure the lens 20 to the circuit board 30.

The first light emitting surface 22 is a convex curved surface. The first light emitting surface 22 and the light incident surface 21 cooperatively form a convex lens portion, the convex lens portion can focus the light emitted from the light source 10. The light emitted from the light source 10 has a relative smaller divergence angle after being focused by the convex lens portion, and thus can be used for long-distance illumination. When the light source module 100 is used in a vehicle lamp, the light radiated from the first light emitting surface 22 can be used for illuminating the distant place ahead of the vehicle. The convex lens portion has an optical axis O and a focal point located at a side of the lens 100 adjacent to the light incident surface 21. In the present embodiment, the focal point is located in the receiving recess 211. The light source 10 is located at the focal point; thus, the light radiated from the first light emitting surface 22 is substantially parallel light. The first light emitting surface 22 includes a first border 221.

The second light emitting surface 23 is located at a side of the first light emitting surface 22 and adjacent to the first border 221. The longer the distance between a point of the second light emitting surface 23 and the optical axis O is, the longer the distance between the point and the light incident surface 21 is, so that the light radiated from the second light emitting surface 23 will deflect away from optical axis O. When the light source module 100 is used in a vehicle lamp, the second light emitting surface 23 can be arranged at a side of the first light emitting surface 22 adjacent to the ground, and the light radiated from the second light emitting surface 23 can be used for short-distance illumination to illuminate the ground.

In the present embodiment, the projection area of the second light emitting surface 23 on a plane perpendicular to the optical axis O is smaller than that of the first light emitting surface 22; thus, most of the light emitted from the light source 10 can be used for the long-distance illumination.

The connecting surface 24 can reflect the light incident thereon towards the first light emitting surface 22 for the long-distance illumination. In the present embodiment, the light connecting surface 24 is substantially parallel to the optical axis O, most of the light incident on the connecting surface 24 experiences a total reflection. The light connecting surface 24 can further has a light reflective film formed thereon.

In the present embodiment, the projections of the first light emitting surface 22, the second light emitting surface 23, and the connecting surface 24 on the plane perpendicular to the optical axis O cooperatively form a circle.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope and spirit of the appended claims.

What is claimed is:

1. A lens comprising:
a light incident surface, the light incident surface being a concave surface and defining a receiving recess;
a first light emitting surface, the first light emitting surface being a convex curved surface and opposite to the light incident surface, the first light emitting surface comprising a first border, the first light emitting surface and the light incident surface cooperatively forming a convex lens portion with an optical axis; and
a second light emitting surface located at a side of the first light emitting surface adjacent to the first border, the longer the distance between a point of the second light emitting surface and the optical axis being, the longer the distance between the point and the light incident surface being.

2. The lens as claimed in claim 1, wherein the light incident surface is a concave curved surface.

3. The lens as claimed in claim 1, wherein the lens further comprises a ring-shaped flat surface surrounding the light incident surface, the ring-shaped flat surface extends from the edge of the light incident surface.

4. The lens as claimed in claim 1, wherein the convex lens portion has a focal point located in the receiving recess.

5. The lens as claimed in claim 1, wherein the lens is used in a vehicle lamp, the second light emitting surface is arranged at a side of the first light emitting surface adjacent to the ground.

6. The lens as claimed in claim 1, wherein the projection area of the second light emitting surface on a plane perpendicular to the optical axis is smaller than that of the first light emitting surface.

7. The lens as claimed in claim 1, wherein the lens further comprises a connecting surface connecting the first light emitting surface to the second light emitting surface, and the connecting surface is substantially parallel to the optical axis.

8. The lens as claimed in claim 7, wherein the light connecting surface comprises a light reflective film formed thereon.

9. The lens as claimed in claim 7, wherein the projections of the first light emitting surface, the second light emitting surface, and the connecting surface on a plane perpendicular to the optical axis cooperatively form a circle.

10. A light source module comprising:
a light source; and
a lens, the lens comprising:
a light incident surface facing the light source, the light incident surface being a concave surface and defining a receiving recess;
a first light emitting surface, the first light emitting surface being a convex curved surface and opposite to the light incident surface, the first light emitting surface comprising a first border, the first light emitting surface and the light incident surface cooperatively forming a convex lens portion with an optical axis; and
a second light emitting surface located at a side of the first light emitting surface adjacent to the first border, the longer the distance between a point of the second light emitting surface and the optical axis being, the longer the distance between the point and the light incident surface being.

11. The light source module as claimed in claim 10, wherein the light source is received in the receiving recess.

12. The light source module as claimed in claim 10, wherein the light incident surface is a concave curved surface.

13. The light source module as claimed in claim 10, wherein the lens further comprises a ring-shaped flat surface surrounding the light incident surface, the ring-shaped flat surface extends from the edge of the light incident surface.

14. The light source module as claimed in claim 13, wherein the light source module further comprises a circuit board, the light source is a light emitting diode mounted on the circuit board, and the ring-shaped flat surface is attached to the circuit board.

15. The light source module as claimed in claim 10, wherein the convex lens portion has a focal point located in the receiving recess, and the light source is located on the focal point.

16. The light source module as claimed in claim 10, wherein the lens is used in a vehicle lamp, the second light emitting surface is arranged at a side of the first light emitting surface adjacent to the ground.

17. The light source module as claimed in claim 10, wherein the projection area of the second light emitting surface on a plane perpendicular to the optical axis is smaller than that of the first light emitting surface.

18. The light source module as claimed in claim 10, wherein the lens further comprises a connecting surface connecting the first light emitting surface to the second light emitting surface, and the connecting surface is substantially parallel to the optical axis.

19. The light source module as claimed in claim 18, wherein the light connecting surface comprises a light reflective film formed thereon.

20. The light source module as claimed in claim 18, wherein the projections of the first light emitting surface, the second light emitting surface, and the connecting surface on a plane perpendicular to the optical axis cooperatively form a circle.
